(19) United States
(12) Patent Application Publication
(10) Pub. No.: US 2013/0144682 A1
(43) Pub. Date: Jun. 6, 2013

(54) SYSTEM AND METHOD FOR ENHANCING COMMUNICATION SERVICES BASED ON USER BEHAVIOR AND RELATIVE TRENDING PATTERNS

(71) Applicants: Krishna Kishore Dhara, Dayton, NJ (US); Prasad Vishwas Katre, Pune (IN); Venkatesh Krishnaswamy, Holmdel, NJ (US)

(72) Inventors: Krishna Kishore Dhara, Dayton, NJ (US); Prasad Vishwas Katre, Pune (IN); Venkatesh Krishnaswamy, Holmdel, NJ (US)

(73) Assignee: Avaya Inc., Basking Ridge, NJ (US)

(21) Appl. No.: 13/308,832

(22) Filed: Dec. 1, 2011

(51) Int. Cl. G06Q 10/00

(52) U.S. Cl. 705/7.29

(57) ABSTRACT

Disclosed herein are systems, methods, and non-transitory computer-readable storage media for enhancing communication services based on relative trending. A system configured to practice the method identifies, from a set of historical communication data associated with a user, relative trending data. Based on the relative trending data, the system identifies a plurality of communication periods within the historical communication data. For a time series associated with one of the communication periods, the system identifies a relative trending pattern in the relative trending data, and performs an action based on a comparison of current communication data to the relative trending pattern for a respective communication period. The communication period can be a fixed, recurring duration of time. The relative trending data is typically associated with at least one variable, which may be, for example, a second user. The system can identify and use trend peaks, patterns, and confidence levels in this approach.

### BACKGROUND

1. Technical Field

The present disclosure relates to communication services and more specifically to enhancing communication services based on relative trending patterns and periods identified from the relative trending patterns.

2. Introduction

Consumer communication is increasingly driven by services or applications that rely on inferred user behavior. This user behavior is discovered either as an aggregate across various entities, such as in recommender systems, or as a marketing or advertising tool, such as in online social networks (OSNs), or as a personalized implicit social graph, such as in inferring or suggesting friends. The knowledge discovered is used to enhance consumer communication applications, such as contacts or related people/friends used by consumers on their desktops, mobile phones, and/or on their email clients. These applications can be extended with OSN Application Programming Interface (API) to allow users to reach out to a wider set of people.

However, even such extended contact application suffers from two major limitations. The first limitation is associated with the increasing number of contacts and the need for an additional “search” mechanism in the contacts. The second limitation is the static nature of the contacts. In other words, all the contacts in a user's profile are statically provisioned by the user and are grouped statically. Consumers, especially enterprise users, operate in many contexts and may require a completely different set of people in their contact or relevant people depending on the time of day or their activity. Current approaches do not address these issues.

Existing systems predict relevant people based on multi-modal communication activity and on email activity, such as Google's friend suggestions. These communication systems determine the order of the people by the total amount of communication activity. However, such systems fail to detect above normal activity for low communicating people. This problem is critical for enterprise users where above normal activity for low communicating people, such as someone higher up in the corporate hierarchy, could be quite important. Hence, there is a need to rank such people higher or present an alternate view of such people.

Another problem with existing systems, especially for enterprises, is the inability to identify trending patterns that could suggest certain kinds of activity at certain times. Communication activity from certain people could be normal during certain hours, such as regular or scheduled meetings, calls, or emails from certain people in the morning, but even low activity outside those hours could indicate a significant change, such as communications in the afternoon or on weekends. Current systems that rely on historical trends and on short term activity do not capture these changes and miss out on predicting relevant people.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Many network services such as email services and online social networking applications offer enhanced capabilities to standard communication services by mining user data. Examples of such services are friend suggestions, marketing recommendations, etc. This disclosure enhances related people or a simple contacts application by inferring a dynamic set of relevant people for users at any given time using models for influences of multi-modal communication units that determine the relevance score of people.

Previous work is based on either past history or upcoming activity and on existing relations, without considering relative trending and/or abnormal activity during a period of time for communication services. Further, previous work does not look at ‘hourly’ or ‘day of the week’ activity and availability for collaboration. This approach introduces the notion of a relative trend based view of relevant people for a user at any given time and new services that use relative trend based patterns for enhancing communication services. Relative trends capture “relative” changes in scores, and can indicate deviation from normal behavior. Relative trends can be based on mined or identified communication periods, such as 60 minutes, 24 hours, 7 days, or other periods.

The principles set forth herein disclose how to infer relevant people based on users' historical and upcoming communication activity, and its application to consumer communication services. Inferring relevant people from communication activity is different from recommender or recommendation systems. Recommender systems use aggregation of user's evaluation of one entity in relation to another for recommendations. For relevant people the behavior is private and temporal. That is, the set of relevant people can change frequently though the related people or pre-provisioned contacts may not change. It is also different from suggesting friends in OSN and email as the communication involves not the past history but current context and upcoming events, such as conference calls. Further, the multi-modal nature of communication can have different influences on the relevance of people at any given time. This approach combines models that capture computation of influence for each modality of communication unit, either periodically or in real-time, to score the relevance of a person communicating with a user. A service based on the principles set forth herein can infer relevant people based on users' communication activity, predict relevant people based on current and upcoming activity, and include multi-modal nature of communication in the analysis.

Disclosed are systems, methods, and non-transitory computer-readable storage media for enhancing communications based on relative trending patterns. A system configured to practice the method identifies, from a set of historical communication data associated with a user, relative trending data. Based on the relative trending data, the system identifies a plurality of communication periods within the historical communication data. For a time series associated with one of the communication periods, the system identifies a relative trending pattern in the relative trending data. Then the system can perform or enhance an action based on a comparison of current communication data to the relative trending pattern for a respective communication period.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates a block diagram of a two-tiered approach for computing relevance of communication units;

FIG. 3 illustrates a mean arrival distribution μₐ for modeling communication unit activity;

FIG. 4 illustrates normalization for mean value comparison for modeling communication unit activity;

FIG. 5 illustrates phases of an exemplary event for modeling event communication unit activity;

FIG. 6 illustrates scaling PDFs and factors associated with the event of FIG. 5;

FIG. 7 illustrates an example system architecture for detecting and using relative trending in communication events; and

FIG. 8 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

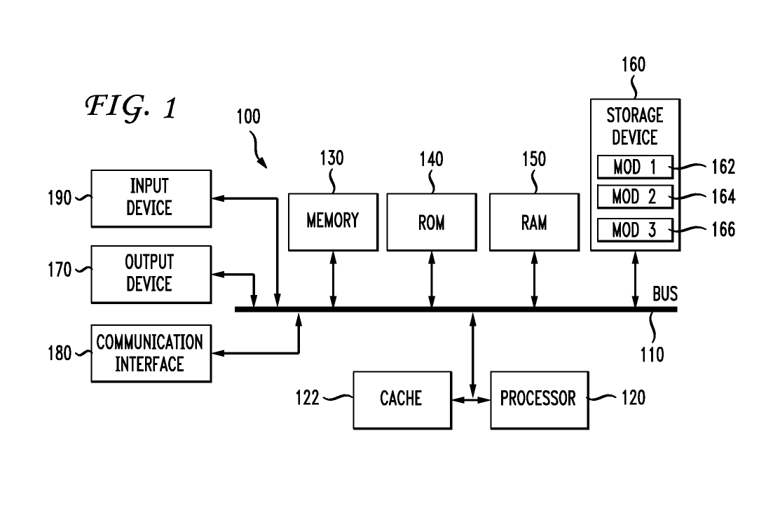

The present disclosure addresses the need in the art for improving communication services by identifying and exploiting pattern mining and relative trends for a given time period in a user's communication history. A brief introductory description of a basic general purpose system or computing device in FIG. 1 which can be employed to practice the concepts is disclosed herein. A more detailed description of relative trending, communication patterns and example use cases will then follow. These variations shall be discussed as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output system (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod 1 162, Mod 2 164 and Mod 3 166 which are modules configured to control the processor 120. These modules may be stored on the storage device 160 and loaded into RAM 150 or memory 130 at runtime or may be stored as would be known in the art in other computer-readable memory locations.

Having disclosed some components of a computing system, the disclosure now returns to a discussion of relative trending. Relative trending can be applied to communication services. Further, behavioral patterns can be used to guide behavior of communication services based on relative trending instead of rule-based logic. Relative trending and the use of patterns based on relative trending can significantly enhance communication services. These approaches focus on relative trending for identified communication periods instead of simple trending as a measure to list people who are active over a given period, such as in a predictive contact application, and on proposing patterns to be identified from user communication activity for enhancing unified communication services.

Regarding relative trending, trending is defined as the increase or decrease of a measured value over time. For example, in airline prices, trending shows the movement of the price of the ticket over a time period. Certain websites measure the popularity of a news article/page by measuring the increase or decrease of the number of visitors over a period of time. These approaches are referred to as simple trending.

For communication context, for each user and for each person communicating (via email, call, event, or IM, etc.) with the user, the system computes a score to represent their communication activity at any given time. Using a similar simple notion of trending as above, a difference of score over a period of time, captures people with high communication over a period of time. While this may be useful, this approach does not prevent high communicating people from obscuring low communicating people. Relative trending can resolve this issue.

An exemplary system computes the trend view from the perspective of one user for other users and mines for patterns, such as “peak hour”, “active period”, and so forth. The system incorporates a relative notion of trending scores. Typically, trending is defined as the gradient of an observed variable. However, when applying trending scores to communications, the system uses relative trending. A trend increase in 0.2 for a person is different at different levels. That is, a 0.2 absolute increase for a person with low score and the same 0.2 absolute increase for a person with an already high score have different significance. Two trends having a same absolute value (i.e. increase or decrease) may have different scores or weights when the trends are in different ranges. Relative trending can be based on different layers of a person's scores. The system analyzes a series of relative trend scores over a period of time to determine periods. The system transforms the time series to a Fast Fourier (or frequency) series to generate a periodogram and uses autocorrelation to select appropriate periods. For example, the system can convert the time series into frequency series using x(n)→X(f_{k/N}). The system can use N/2 frequencies, as per the Nyquist Theorem, and the compute the periodogram function for each frequency using P(f_{k/N})=∥X(f_{k/N})² k=0, 1, . . . (N-1)/2. Then the system can mine the periods for patterns, such as a “trending hour” or an “active hours” pattern. The system can mine these patterns by selecting frequencies with high periodogram values.

For example, the system can determine a “trending hour” pattern by performing the following steps for each period: (a) select a random day from the relative trending series, (b) for all the peaks in the span of an hour, look for similar peaks (going back in time and forward in the time series from the random day chosen in steps of the chosen period), and compute the confidence level (ratio) of the peaks, and (c) report the pattern with the confidence level. The system can determine an “active hours” pattern, by performing the following steps for each period: (a) select a random day from the relative trending series, (b) for all the peaks in the span of an hour, mark the first negative relative trending score as an active period, then go back and forward in time series in steps of the chosen period and find the confidence (ratio) level of the patterns found, and (c) report the pattern with the confidence level. Thus, the system can mine peak and active hour patterns for each user and each person. Peak hour patterns reflect periods of higher trends above a threshold. The active hour pattern reflects the window of increasing and decreasing trends. The system can assume that if a score is not available for a time period t, then the trend of t for that time period is 0. The system can select frequencies having peaks with values higher than at least 50% of the frequencies, and unselect frequencies for which the corresponding periods are not in close proximity to multiples of 24 hours, in the case of searching for events that occur on a daily basis or some other day-based period.

In one example use case for relative trending, users receive communications such as emails, instant messages, calendar events, and phone calls from their team members. Thus, their scores, and hence trending of their team members, are high. However, if a user wants to see an alternate, trending view of relevant people, showing the same set of people is not of much use. A few emails or calls from their administrative assistant or their supervisor may require immediate attention. The volume of communication from the administrative assistant or supervisor may not be higher but in terms of relevance could be quite important. A simple trending of communication score over time does not show the change in activity of this person who is very important but has low communication score, and a low change in score because of one email, instant message, or phone call. Relative trending highlights such relevant communication.

Relative trending over time can provide significant benefits over a simple trending over time for various communication services, such as predictive contacts with trending option, finding patterns of people to predict who might be important on a particular day of the week or during a particular hour, or finding active hours of a user by looking at the relative trending patterns of communication score.

Further, the system can identify patterns in relative trends and leverage those patterns for enhancing communication context services. Relative trending normalizes a communication score of a person with respect to their activity in relation to a user. While this in itself is useful as discussed above, this score can further identify ‘usage’ patterns that allow communication services to base decisions on users' specific data rather than relying on specialized or generalized rules, such as in rule-driven systems. This approach uses behavioral patterns mined from users' communications. These patterns drive behavior and functionality of communication services instead of a set of rules, which are potentially very complex to approximate similar functionality and which do not adapt with changing user work habits without explicit modifications. The following three examples highlight the usage of such patterns in communication services.

In a first example, identifying relative trending patterns for each user for each hour allows the system to predict the relevant people for a user for that hour. This can be combined with a group of people and their presence and availability. For instance, Alice has Bob and Charlie trending every Wednesday morning at 9:00 am. Predicting Bob and Charlie as important every Wednesday morning at 8:45 am allows Alice to access them easily, such as in one click. Further, if Bob is unavailable, a communication service for setting up meetings can suggest that Alice meet with Charlie instead of Bob based on their respective data specific to Alice, and not necessarily based on any general rule-based engine, which would be different for different users.

In a second example, the system identifies another pattern of ‘active hours’ of a user. For example, from Alice's communication score, which can include responses from Alice, the system can infer Alice's active or working hours, rather than relying on a more traditional 8:00 am to 5:00 pm work schedule, which may or may not reflect Alice's actual work pattern. Mining specific active hours can help in many communication services. In addition to relying on availability and interrupting people on their non-active/non-working hours, communication services can find people based on their active hours, such as tech support or customer service. Active hours are not mandated (as in a call center schedule) but mined from Alice's behavior. These active hours can vary for different days of the week. For example, if Alice attends a class on Wednesday and is not active from 3:00 pm to 5:00 pm on Wednesdays, the system can mine that information from her behavior without any specific rules. This pattern can then influence routing, scheduling, and/or communication attempts associated with Alice.

The third example is a modification or extension to the second example above. In this example, the system determines active hours of a user on a per person basis. Alice can be ‘active’ for Bob and not for Charlie on Monday mornings. This information can enrich communication services and/or user experience for Alice while predicting relevant contacts or providing other communication related services.

Without the concept of ‘active hours’ the system is unable to effectively predict relevant people. For example, a team working in a different time zone or a person with a work schedule that is non-standard may be of little help in resolving or discussing a particular issue. The system can reconcile ‘active hours’ across multiple time zones.

When starting, the system can mine peak hours for every person corresponding to a user. Then the system can use this data to mine an active hours pattern. For example, the system can mine for peaks in the original sequence of trend score vs. time for a period, and when a peak is found, the system can shift by a period and search for peaks again, until a threshold certainty is reached and the peak is positively identified. Conversely, the system can eliminate, narrow, or otherwise modify peak hours based on low confidence or certainty levels.

Further, reliance only on presence and availability restricts adaptability, whereas relative trending provides significant adaptability. For example, Alice always communicates or is available for Bob from 9:00 am to 11:00 am and with Charlie from 1:00 pm to 3:00 pm, but on Mondays, she is available for Bob from 9:00 am-10:00 am and for Charlie from 10:00 am-11:00 am. Clearly, this could get quite complex with more people and with Alice's preferences and schedule. Systems that rely on presence and availability depend on Alice to meticulously provide input or to program a fragile, error-prone rule-based system that matches her behavior, which actually could change over time and with people. Instead, this disclosure relies on little or no explicit input from Alice, but instead analyzes patterns in historical behavior and provides ‘active hour’ information for communication services that rely on it.

These approaches can enable or enhance multiple services, three of which are summarized herein. First, relative trending enables a new view of relevant people based on the trending. The view does not include related people based on communication history or normal communication activity, but rather people who at that moment exhibited above normal communication activity that indicates a need to respond or view their activity. Second, relative trending enables the system to list people that are active based on user behavior. The system can identify a set of people that are active for a given user during a certain hour of the day or certain day of the week. Predictions based on that information allow the server to identify relevant people based on the hour of the day or day of the week or appropriately identify activity as normal for that hour/day. Third, the system can discover active hours for a set of people in order to understand the availability of a user for that group related activity. Communication services based on such predictions can reach appropriate people based on active hours patterns. For example, if a person works with different sets of people located in different geographical locations, the active hours pattern allows us to identify the hours of activity for that user and associated with each set of people. This is specific to the behavior of a particular user and does not necessarily coincide with work hours. If the user or a service on behalf of the user needs to reach out to a person, this pattern can help determine whether and how to reach the appropriate set of people, or which individuals of the set of people are reachable at a given time.

The system can use the relative trending information, patterns, peak hours pattern, and active hours pattern to influence, select, and/or reorder a list of contacts in an address book, for example. The system can provide an interface for the user to view the underlying trending information, peaks, and other data that led to a particular contact's placement, and flag certain components of the underlying trending information as relevant or not relevant, which can affect the placement of that contact and/or other contacts in real time. Alternatively, the user can make temporary changes to preview how those temporary changes would influence the placement (or other system action(s)) without committing to the temporary changes. When the user is happy with the temporary changes, the user can then make the temporary changes active.

The disclosure turns now to a foundational discussion of predictive contacts and how to infer relevant people from multi-modal user communication activity, although the same principles can be applied to enhancing other communication services beyond inferring relevant people, and can include uni-modal and multi-modal user communication activity. These principles are separate from the discussion of computing relative trending and identifying or mining communication periods from the relative trending data.

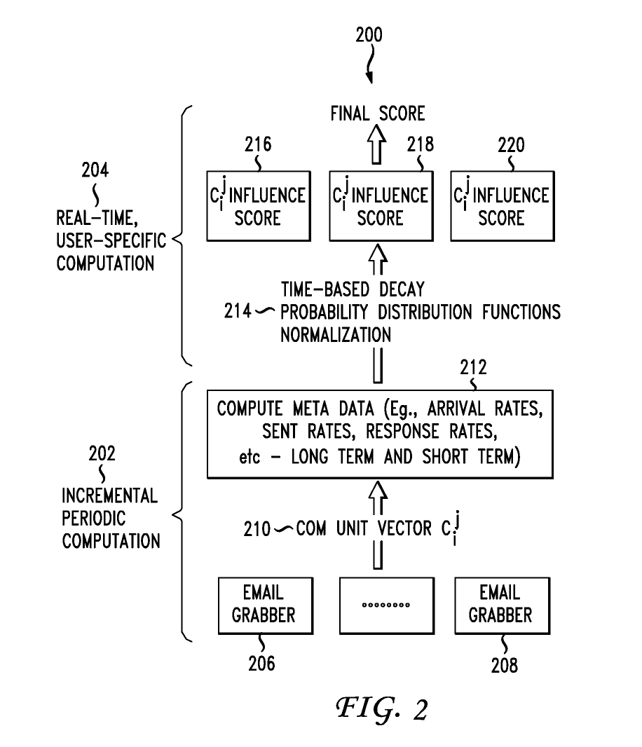

FIG. 2 illustrates a block diagram of an example architecture 200 implementing a two-tiered approach for computing relevance of communication units. This architecture 200 split the computation of influence of communication units into two categories, an incremental periodic computation 202 category and a real-time user-specific computation 204 category associated with user-specific temporal behavior. This architecture 200 presents an overview of an example two-tiered approach for computing the influence of various communication units Cᵢ^{j} and the relevance of the communication units Cᵢ^{j} 210 for predicting relevant people for a user. The bottom incremental periodic computation 202 category shows grabbers 206, 208 for individual units extracting data for processing. For example, the email grabber 206 periodically extracts information from email servers such as MS Exchange, web mail, and so forth. The incremental periodic computation 202 tier captures, if necessary, meta-data that may be used by the upper real-time user-specific computation tier to compute the score of a person with respect to a user, pᵢ^{j}. As new communication units are grabbed from their sources, the periodic analyzers compute various metrics and store them as meta-data 212, such as long term and short term arrival rates, sent rates, response rates, and so forth, irrespective of their use in the final computation. This way, the real-time computation of scores is separated out from historical data. The computation in this tier can be incremental, such that when new communication units arrive, the computation should be bounded and should not look at all the communication units prior to that new email.

The real-time user-specific computation 204 tier shows real-time computation for calculating pᵢ^{j} based on various communication units \vec{c}ᵢ^{j}. This computation can be invoked on demand, that is when a client requests an ordered list of people or could be pre-computed periodically to minimize latency. This tier combines the meta-data 212 available for various communication units with appropriate decay values 214 to account for elapsed time from the computation of the meta-data in the lower tier. This computation can include user preferences in combining the contribution of various Cᵢ^{j} scores 216, 218, 220 from various communication units to the final score 222 of a person.

This two tiered approach leaves enough flexibility for computing the contribution of an individual communication unit cumulatively or in real-time or both. The disclosure turns to a discussion of computing specific communication units. The computation depends on how each communication unit is modeled, which in turn leads the periodic meta-data computation and real-time score contribution. Communication units can include emails, events, calls, and virtually any other form of communication.

Email communication forms a major component of many enterprise users' communications. However, the volume of email need is not necessarily indicative of importance. While lexical analysis, such as keyword extraction, topic modeling, and so forth can capture the importance of their contribution and hence the relevance of the participants, this approach looks at metrics that consume an order of magnitude lesser resources. The performance requirements of this service are strict and for each communication unit would be in the order of a few milliseconds. Hence, this approach does not need to rely on or even use content-based analysis.

The system can model emails with the Poisson process, which is incremental. To capture the importance of emails, the system can compute arrival rates, sent rates, and response rates of emails. For example, a small response rate can indicate that the participants are more important than received emails with low or medium arrival rate. This prevents spam or unsolicited mail senders from having a higher score than the senders of a mail that the user responded to or a mail that the user initiated.

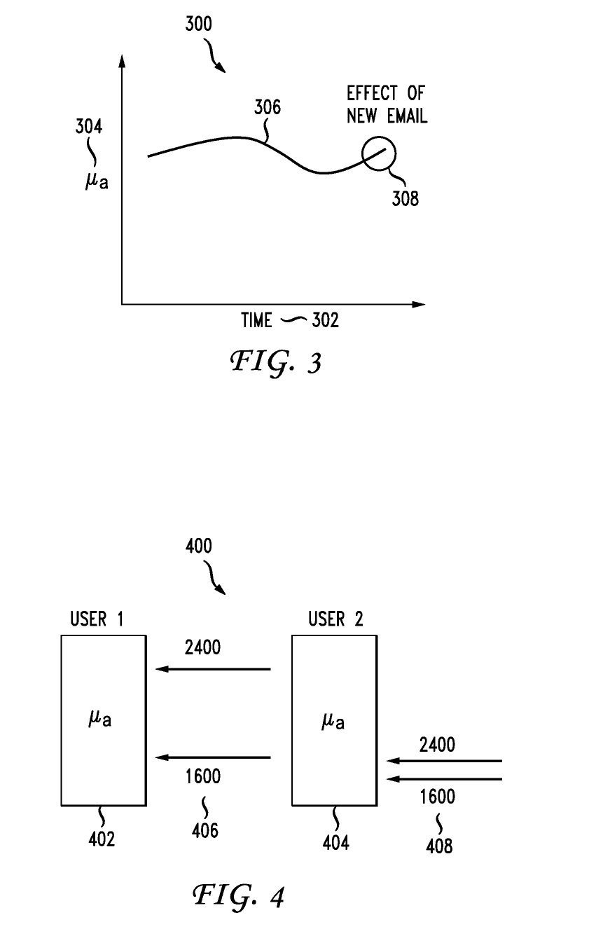

FIG. 3 illustrates a chart 300 of mean arrival distribution 306 of the mean arrival rate μₐ 304 over time 302 for modeling communication unit activity. The mean arrival rate, mean response rate, and the mean sent rate model email communication. As new emails (received or sent) are grabbed, their respective cumulative means are computed incrementally, as reflected in the circled portion 308 of the chart 300. FIG. 4 illustrates normalization 400 for mean value comparison for modeling communication unit activity, which demonstrates a subtle but important step in comparing the values of various means. For example, for user 1 402, if the mean arrival rates for two people are 1600 and 2400 408, and for user 2 404 the mean arrival rate for two people are 1600 and 2400 406. The system can compute the influence of the mean arrival rates for user 1 402 and user 2 404. If user 1 402 has high communication activity, a mean sent score of 1600 can result in higher influence score and a mean sent score of 2400 can result in a lower influence score. Similarly, if user 2 404 has low communication activity, both mean sent rates of 1600 and 2400 could mean the two people have high influence score.

This reflects the need for relative communication thresholds and relative trending scores as set forth above. To model ‘relative’ strengths of mean arrival and mean response time for the recipients, the system can normalize mean values of each person with respect to that user. Hence as part of the metadata in the periodic computation, for each user the system can compute the mean of all means, and the variance with an incremental approximation. For each user, for each person, the system can normalize their mean rates based on how far they are with respect to that user's mean of all means and variance.

The system can perform periodic computation of meta-data for email communication units. This computation is performed for each user with new email during that period, sent or received, and for only the participants in each of the email list. The computation includes the following steps. First, for each email (received or sent) get the recipients (including the sent person) list. Second, compute mean arrival, μₐ or μₛ and μᵣ, time using a distribution function.

μₐ=*μ′ₐ+(1−)*t

where μ′ₐ is the previous mean arrival rate and t is the time interval since last mail.

Third, update mean of all means and variance of all time mean. Fourth, normalize the mean values based on its distance with respect to mean of all means and the variance. The real-time computation uses these values to calculate a final influence score for emails.

The real-time computation involves the following steps. First, compute short term mean arrival, response, and sent scores. The short term is a user-configurable metric, such as one day, three days, or one week. A default value can be used in the absence of explicit user configuration. Second, compare the decayed short term and long term (periodic mean values) and choose the higher value. The decay function decays the score as a function of the time since last sent or received mail to this person. The decay function can be proportional to normalized score (high or low) and the elapsed time (how close is it to the high or low before normalization). Third, for each person, compute email influence score,

Iᵤ^{p}=γ₁* arrival score+γ₂* sent or response score

where parameter and could user defined or learned from user behavior. These may be configurable by the user and we use values of one-third and two-thirds for arrival and sent/response score coefficients as default.

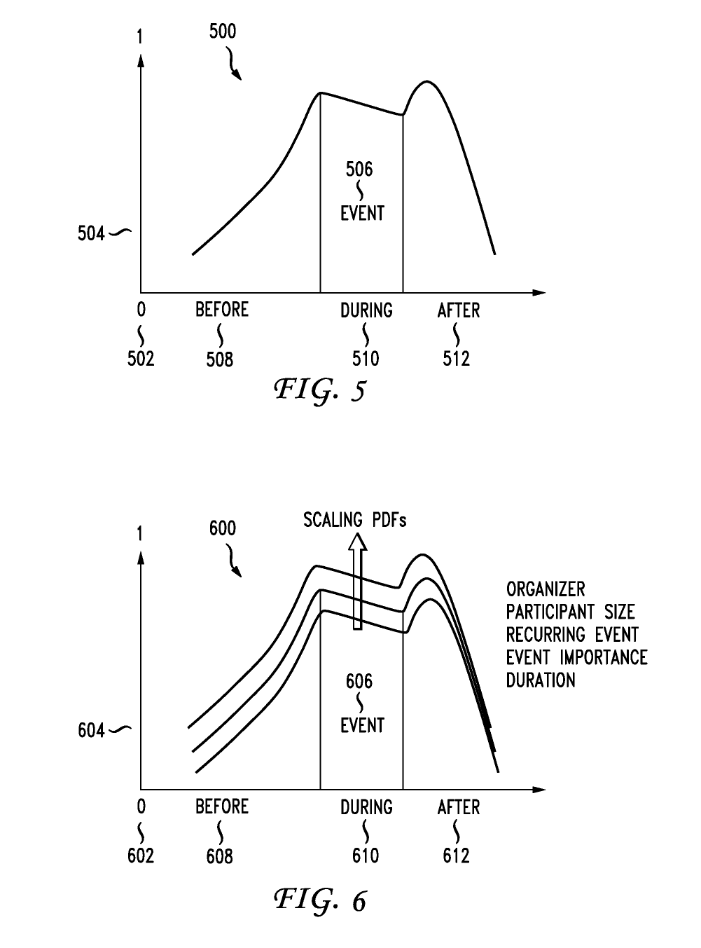

The event grabber or meeting communication unit contrasts with the email grabber or call communication units. The intent of a meeting invite is to communicate at a future scheduled time and the importance of the participants of the meeting invite to a user depends on the pre-scheduled time and on the other characteristics of the event. These events can be modeled mostly as three discrete phases of an event 506 as shown by the chart 500 in FIG. 5: before the meeting 508, during the meeting 510, and after the meeting 512. The chart 500 represents importance over time 502 on a scale 504 of 0 to 1. Leading up to the meeting 508, the importance of the participants increases as the scheduled time for the meeting approaches peaking at the start of the meeting. During the meeting 510, the importance decreases with a small gradient, generally remaining high, and after the meeting 512, the importance goes up slightly and drops down quickly. The small increase at the end of the meeting can capture the need for setting up follow up communication or for sending meeting minute to participants. Three different probability distribution functions can model this behavior.

Typically, meeting or events could be short or long. A daylong meeting does not need to have the same influence throughout the day. Similarly, the organizer of a meeting can have higher score in case one needs to reach out to the organizer at the last minute for any changes. Further, if the meeting is a daily meeting, scoring the participants higher every day might push people with scores that are trending up, so the system can use a scaling factor that looks at various characteristics of a meeting and scales the probability distribution functions in the three phases appropriately

The chart 600 of FIG. 6 illustrates scaling probability distribution functions (PDFs) and factors associated with an event 606 over time 602, and scaled from 0 to 1 604. As in FIG. 5, the chart is divided into three discrete phases: before the event 608, during the event 610, and after the event 612. FIG. 6 shows the scaling of various probability distribution functions. The goal is to score the organizer of a short, occasional meeting with fewer participants higher than a participant in a longer or higher priority meeting that is recurring with a high number of participants. The system can scale the PDF based on organizer, number of participants, recurrence, importance, and/or duration, for example. Other factors and mixes of factors can be used as well.

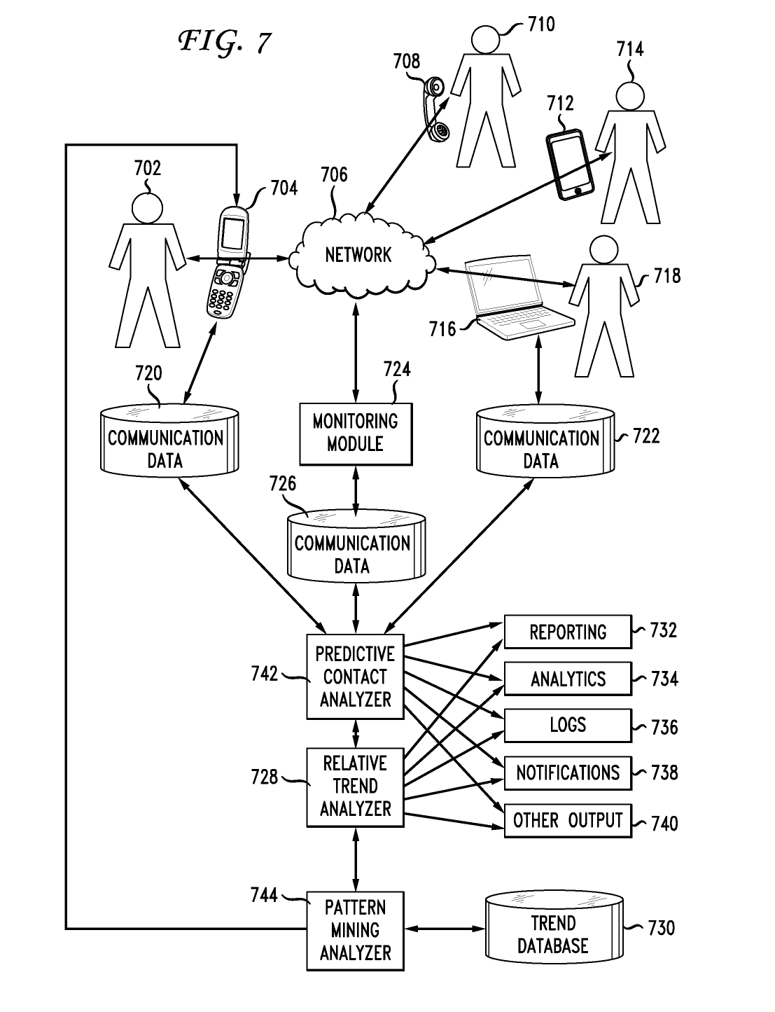

Having disclosed some aspects of predictive contacts, the disclosure now returns to a discussion of relative trending and mining communication periods from relative trending data. FIG. 7 illustrates an example system architecture for detecting and using relative trending in communication events. Alice 702 communicates via a cellular phone 704 or other device via a communications network 706 with Bob 710, Charlie 714, and Diane 718, each with their own respective communication devices 708, 712, 718. As the communications occur, the devices can gather and store or report communication data 720, 722 associated with those communications. A network-based monitoring module 724 can also gather communication data 726, such as a network router, a SIP router, or network infrastructure component.

A predictive contact analyzer 742 receives and/or gathers the communication data from one or more of these sources 720, 722, 726, and can organize the data by user. A relative trend analyzer 728 coordinates with the predictive contact analyzer 742. Trend data is relative change in the predictive contact analyzer. The relative trend analyzer 728 analyzes the data to identify relatives trends, as set forth above. This data can be stored in a trend database 730 by the relative trend analyzer 728 or the pattern mining analyzer, for example.

A pattern mining analyzer 744 identifies patterns and infers periods based on the relative trending, such as peak active periods with a particular user or set of users, and the active or available hours of a user. Further, the pattern mining analyzer 728 can provide feedback to users' communication devices, such as back to the cellular phone 704 of Alice 702, instructing the cellular phone to rearrange a list of contacts based on relative trends in Alice's communications for a given period. The pattern mining analyzer 728 can also provide other communication services such as routing for experts, colleagues, or finding relevant people, and so forth.

Further, the relative trend analyzer 728 and/or other component can output data in various other ways, such as reporting 732, analytics 734, logs 736, notifications 738, and other output 740. Users can log in to the relative trend analyzer 728 and manage data stored in the trend database 730 regarding their communications, such as to correct or modify a detected pattern or to indicate that communications from a particular user should be assigned a higher importance.

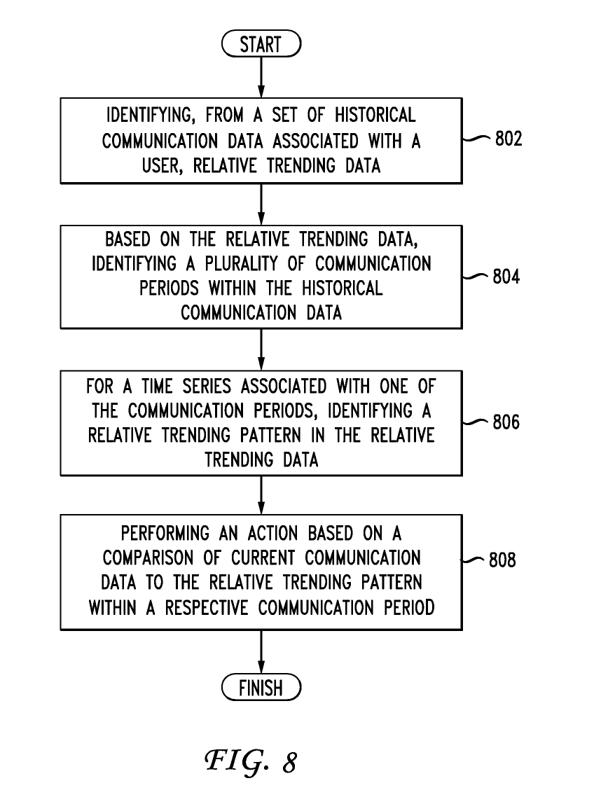

Having disclosed some basic system components and concepts, the disclosure now turns to the exemplary method embodiment shown in FIG. 8. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps.

A system configured to practice the method identifies, from a set of historical communication data associated with a user, relative trending data (802). The relative trending data can be associated with at least one variable, such as a second user. Based on the relative trending data, the system identifies a plurality of communication periods within the historical communication data (804). The communication period is a fixed, recurring duration of time. For example, the communication period can be 24 hours (i.e. every day), 48 hours of business days (i.e. every other weekday excluding holidays), 168 hours (i.e. one every week), 30 minutes, or any other recurring duration. The durations can be measured in smaller or larger increments than hours, such as minutes, weeks, or months. For example, the communication period for two closely collaborating researchers may be measured in tens of minutes, while the communication period for accountants who only meet quarterly may be measured in months.

For a time series associated with one of the communication periods, the system identifies a relative trending pattern in the relative trending data (806). The system can identify relative trending patterns by selecting a day within the historical communication data, identifying a trend peak in a segment of the day, searching for similar peaks at corresponding segments in other days before and after the day to identify a pattern, and computing a confidence level for the pattern, and reporting the pattern and the confidence level.

Then the system can perform or enhance an action based on a comparison of current communication data to the relative trending pattern for a respective communication period (808). The action can include displaying a view of users experiencing above normal communication activity. This action provides an outsider, such as a manager or analyst, a view of which users are exceptionally active right now or at some time in the past, or which users are trending towards high activity. The action can include identifying a set of users associated with the relative trending pattern, and displaying at least a portion of the set of users to the user as indicated by a similarity of the current communication data to the relative trending pattern. The action can alternatively include analyzing relative trending patterns of a group of users associated with a group activity, identify shared periods of availability for the group of users, and displaying a summary of the shared periods of availability to at least one of the group of users. This action can assist groups in coordinating availability for planning future interactions, or for reducing or consolidating duplicate or unnecessary communications.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method comprising:
identifying, from a set of historical communication data associated with a user, relative trending data;
based on the relative trending data, identifying a plurality of communication periods within the historical communication data;
for a time series associated with one of the communication periods, identifying a relative trending pattern in the relative trending data; and
performing an action based on a comparison of current communication data to the relative trending pattern for a respective communication period.

2. The method of claim 1, wherein a communication period is a fixed, recurring duration of time.

3. The method of claim 1, wherein the relative trending data is associated with at least one variable.

4. The method of claim 3, wherein the variable is associated with a second user.

5. The method of claim 1, further comprising, for each of the communication periods, steps comprising:
selecting a day within the historical communication data;
identifying a trend peak in a segment of the day;
searching for similar peaks at corresponding segments in other days before and after the day to identify a pattern, and computing a confidence level for the pattern; and
reporting the pattern and the confidence level.

6. The method of claim 1, wherein the action comprises displaying a view of users experiencing above normal communication activity.

7. The method of claim 1, wherein the action comprises identifying a set of users associated with the relative trending pattern, and displaying at least a portion of the set of users to the user as indicated by a similarity of the current communication data to the relative trending pattern.

8. The method of claim 1, wherein the action further comprises:
analyzing relative trending patterns of a plurality of users associated with a group activity;
identifying shared periods of availability for the plurality of users; and
displaying a summary of the shared periods of availability to at least one of the plurality of users.

9. A system comprising:
a processor;
a memory storing instructions for controlling the processor to perform steps comprising:
identifying, from a set of historical communication data associated with a user, relative trending data;
based on the relative trending data, identifying a plurality of communication periods within the historical communication data;
for a time series associated with one of the communication periods, identifying a relative trending pattern in the relative trending data; and
performing an action based on a comparison of current communication data to the relative trending pattern for a respective communication period.

10. The system of claim 9, wherein a communication period is a fixed, recurring duration of time.

11. The system of claim 9, wherein the relative trending data is associated with at least one variable.

12. The system of claim 11, wherein the variable is associated with a second user.

13. The system of claim 9, further comprising, for each of the communication periods, steps comprising:
selecting a day within the historical communication data;
identifying a trend peak in a segment of the day;
searching for similar peaks at corresponding segments in other days before and after the day to identify a pattern, and computing a confidence level for the pattern; and
reporting the pattern and the confidence level.

14. The system of claim 9, wherein the action comprises displaying a view of users experiencing above normal communication activity.

15. The system of claim 9, wherein the action comprises identifying a set of users associated with the relative trending pattern, and displaying at least a portion of the set of users to the user as indicated by a similarity of the current communication data to the relative trending pattern.

16. The system of claim 9, wherein the action further comprises:
analyzing relative trending patterns of a plurality of users associated with a group activity;
identifying shared periods of availability for the plurality of users; and
displaying a summary of the shared periods of availability to at least one of the plurality of users.

17. A non-transitory computer-readable storage medium storing instructions which, when executed by a computing device, cause the computing device to perform steps comprising:
identifying, from a set of historical communication data associated with a user, relative trending data;
based on the relative trending data, identifying a plurality of communication periods within the historical communication data;
for a time series associated with one of the communication periods, identifying a relative trending pattern in the relative trending data; and
performing an action based on a comparison of current communication data to the relative trending pattern for a respective communication period.

18. The non-transitory computer-readable storage medium of claim 17, wherein the action comprises displaying a view of users experiencing above normal communication activity.

19. The non-transitory computer-readable storage medium of claim 17, wherein the action comprises identifying a set of users associated with the relative trending pattern, and displaying at least a portion of the set of users to the user as indicated by a similarity of the current communication data to the relative trending pattern.

20. The non-transitory computer-readable storage medium of claim 17, wherein the action further comprises:
analyzing relative trending patterns of a plurality of users associated with a group activity;
identifying shared periods of availability for the plurality of users; and
displaying a summary of the shared periods of availability to at least one of the plurality of users.
